(19) United States
(12) Patent Application Publication
(10) Pub. No.: US 2008/0146204 A1
(43) Pub. Date: Jun. 19, 2008

(54) ENHANCED SERVICES FOR MOBILE CONTENT ON DEMAND

(75) Inventors: Neng Gu, San Jose, CA (US); Arun Sobti, Milpitas, CA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: IP Unity Glenayre, Inc., Duluth, GA (US)

(21) Appl. No.: 11/697,120

(22) Filed: Apr. 5, 2007

Related U.S. Application Data
(60) Provisional application No. 60/797,682, filed on May 5, 2006.

(51) Int. Cl. H04Q 7/38

(52) U.S. Cl. 455/414.1

(57) ABSTRACT

The present invention enables mobile service providers to offer a variety of on-demand content and content-related enhanced services to mobile users utilizing existing mobile network infrastructure. In one embodiment, the present invention provides free preview of digital content for users of mobile devices before a call is connected, and gives the option to transition to the charged premium services within a predetermined time. An aspect of the present invention is to provide a real time mobile interactive mode coupled with on-demand services, such as, browsing and selecting a digital content, home mode of content playing, voting on the digital content, joining or creating a chat room to discuss the digital content, making call to others while watching the digital content, inviting others to join the digital content, etc.

### CROSS-REFERENCE TO RELATED APPLICATIONS

The present application claims the benefit of U.S. Provisional Patent Application No. 60/797,682, filed on May 5, 2006, which is incorporated herein by reference in its entirety.

### BACKGROUND OF THE INVENTION

1. Field of the Invention

The invention relates generally to distribution of digital media content and exchange of content-related communications over a wireless network.

2. Background Art

There has been a steady trend towards providing on-demand digital media content to users connected to existing communications networks, such as, the Internet, public switched telephone networks (PSTN) etc. Users are presented with a wide range of options in terms of content and content-related functionalities, if they are willing to pay for the enhanced services. In recent years, service providers have been gradually migrating towards offering similar enhanced services to mobile customers connected to a wireless network.

A variety of digital content is distributed and exchanged over wireless and wired data networks, including digital video, digital audio, text-based instant messages etc. Current mobile digital content services have several problems associated with them. Most of the services are primarily unidirectional, with little or no provision for the user to provide substantial interactive response and feedback. In the case of mobile video content on demand services, such as, mobile TV and streaming video, lack of interactivity option is conspicuous. Users can only enjoy limited video content due to complex, resource-intensive infrastructure requirement and prohibitively expensive air-time.

What is needed is a system that delivers interactive content-on-demand services to mobile customers so that customers can enjoy a satisfying unified communication experience, including exchange of audio, video, text, data, and hypermedia objects, without incurring excessive charges.

### BRIEF SUMMARY OF THE INVENTION

Embodiments of the present invention enable mobile service providers to offer a variety of on-demand content and content-related enhanced services to mobile subscribers utilizing existing wireless network infrastructure.

In an embodiment, a system provides free preview of digital content for users of mobile devices before billing starts, and gives users the option to transition to the charged premium services by making a selection within a predetermined time. The system comprises a preview menu control module that sends out an initial content to a mobile user device for preview by an user after initiation of the call and prior to initiation of a billing charge for the call, and a billing module that initiates generation of billing charges after the user has selected additional content related to the initial content.

According to one feature, the system has a real time mobile interactive mode coupled with on-demand services. Examples of on-demand enhanced services include, but are not limited to, browsing and selecting a digital content, playing the digital content in a home or theater mode, voting on the digital content, joining or creating a chat room to discuss the digital content, making calls to others while watching the digital content, and inviting others to join the chat room.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the relevant art to make and use the invention.

FIG. 1 is a diagram of an example network environment that couples application servers and media servers with mobile users.

FIG. 2 is a diagram showing how video and/or audio programs are multicast to multiple mobile users.

FIG. 3 is a flowchart illustrating the process of delivering mobile content on demand in response to a mobile user's request, according to an embodiment of the present invention.

FIG. 4 shows different interactivity options available on the service menu of MCoD, from which the mobile user can select for premium services, according to an embodiment of the present invention.

FIGS. 5 and 6 show various example components of a media server and a mobile content on demand (MCoD) application server, according to an embodiment of the present invention.

FIG. 7 shows a call flow diagram illustrating how a MCoD application server provides a free preview to users, and coordinates switching from free preview mode to charged premium services mode based on the user's action, according to an embodiment of the present invention.

FIG. 8 shows an example mobile screen displaying enhanced services, according to an embodiment of the present invention.

The present invention will be described with reference to the accompanying drawings. The drawing in which an element first appears is typically indicated by the leftmost digit(s) in the corresponding reference number.

### DETAILED DESCRIPTION OF THE EMBODIMENTS

As technology is evolving towards more network intelligence, mobile customers have started to expect enhanced services and superior communication experience available over existing wireless networks. Mobile service providers have the opportunity to generate substantial revenue by delivering mobile digital content on-demand and content-related interactive services to mobile users, while keeping the operational cost at a reasonable level. While mobile digital content includes purely audio content, purely video content, mixed audio-visual content, text-based content, data content, web content etc., generally, any content involving video has greater demand, requires greater infrastructural resources, and thus, drives the mobile content on demand (MCoD) market.

Mobile video is available today as a service. For example, mobile TV is a broadcast service that requires special broadcast equipment. It is a largely unidirectional video service provided from a provider to a user with limited video programs to choose from. Current implementations of mobile TV do not provide video on-demand and browsing capabilities.

Mobile video streaming requires web capability and the streaming software on the wireless device. Mobile video streams mostly provide pre-recorded video clip services. The cost structure for mobile video is prohibitive. Users are not likely to watch a full length movie or other video program if they have to pay on a per megabyte basis. Generally streaming video solutions may work on a closed-loop intranet, but for mass-market Internet use, they may have quality of service (QoS) issues.

### Example Communication Environment

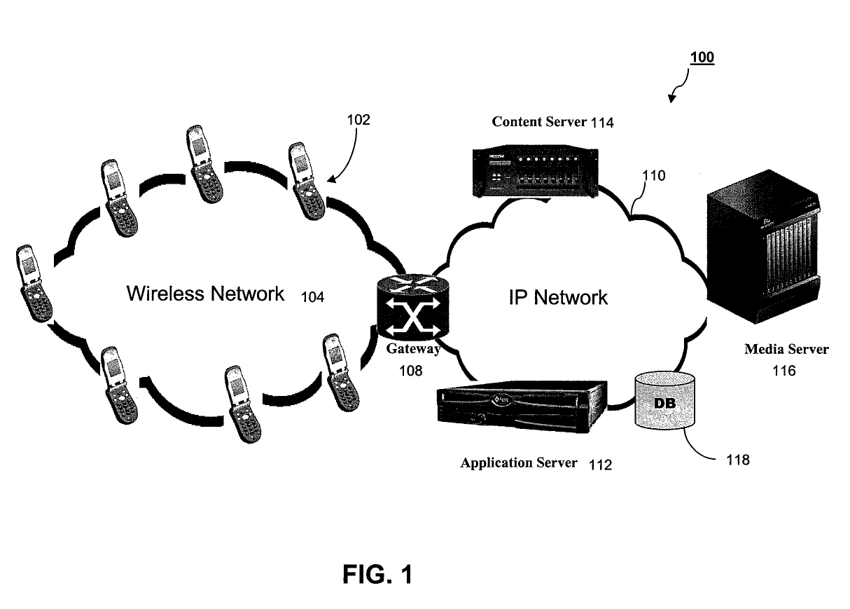

The present invention utilizes the existing capability of an already-deployed wireless infrastructure. The present invention is agnostic to the type of telephone network. For example, the present invention can be implemented in a Voice-over-Internet-Protocol (VOIP) network, but is not limited to VOIP implementations. An example embodiment of the present invention may use the audio and video capability of a current third generation (3G) mobile network infrastructure with the capability to adapt to future generations of wireless networks. FIG. 1 shows an example network environment 100, in which the present invention can be used. Network environment 100 is illustrative and not intended to limit the invention. Network environment 100 may include a number of mobile devices 102 connected to a wireless network 104. Mobile device 102 can be any type of wireless device including, but not limited to, a mobile phone, a computer, a game console, a Wi-Fi device, a wearable watch, a portable digital calendar/timer, a digital notepad, a camera/camcorder, a music player, a portable TV/Digital Video Recorder (DVR), a global positioning system (GPS) device, an embedded system device, or any other mobile processing device. Wireless network 104 may include, but is not limited to, a 3G wireless network. Any number of mobile devices 102 may be connected to wireless network 104. Wireless network 104 is coupled to an Internet Protocol (IP) network 110 through a gateway 108. In an alternative embodiment, gateway 108 may be replaced by an endpoint switch (not shown). Also, gateway 108 may not be necessary when wireless network 104 and IP network 110 converge into a single seamless wireless network. An application server 112 and a media server 116 may be coupled to IP network 110. Media server 116 may locally store digital contents as a repository, or it may channel audio and video contents from another repository, such as, a content server 114 to IP network 110 to be delivered to mobile device 102. Application server 112 is coupled to a database 118, which stores information related to mobile users. Application server 112 and media server 116 communicate with each other, so that application server 112 executes a control logic that regulates the flow of digital content from media server 116 to mobile device 102.

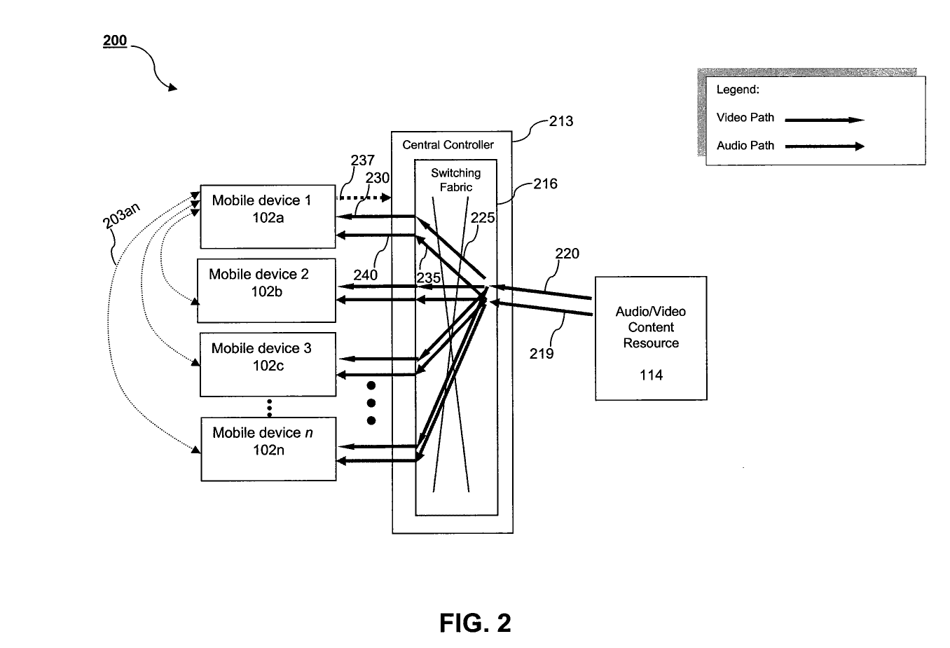

FIG. 2 illustrates multicasting of digital content to a plurality of mobile devices 102a-102n. A multicasting system 200 includes a video and/or audio content resource 114, that transmits an audio signal 219 and a video signal 220. A central controller 213 receives signals 219 and 220, and distributes signals 219 and 220 into multiple signal streams, each of the streams designated for individual mobile devices 102a-102n. In an embodiment, central controller 213 comprises audio and video processing resources of media server 116 and service logic resources of application server 112. Signal distribution is achieved by a switching fabric 216 coupled to the central controller 213. Switching fabric 216, for example, may have a fast ATM switching architecture with a loop back and multicast feature. Switching fabric 216 physically routes individual signal streams to their designated network paths. For example, signal streams 225 and 235 are routed to mobile device 102a, which is capable of processing incoming signals 230 and 240, i.e. playing the video and audio content carried by signals 230 and 240.

It is to be appreciated that, given this description, system 200 may be modified to accommodate bi-directional communication, where mobile devices 102 are enabled to interact with the central controller 213 via interactive signals 237 to access on-demand and other interactive services. Central controller 213 may also be configured to transmit user requests to content resource 114. Content resource 114 then transmits signals 219 and 220, as described before.

In an embodiment of the present invention, mobile devices 102 may interact with each other, as shown in FIG. 2. For example, mobile device 102a and mobile device 102n may interact with each other via a signal 203an.

Users of mobile devices 102 have had an option to be connected to a relatively more resource-intensive route, often associated with higher quality-of-services (QoS), if they are willing to pay extra for premium services. However, a user may want to browse and preview available digital content without switching to premium services. An advantage of the embodiments is to offer a variety of preview services to a user of a mobile device, when the user initiates a regularly-priced call or a sponsored call (such as, the 1-8xx-xxx-xxxx numbers within the US) to a service number, before the call starts generating billing records. The user can browse different options in a preview mode, and make an informed decision about ordering an on-demand content and premium services at higher prices.

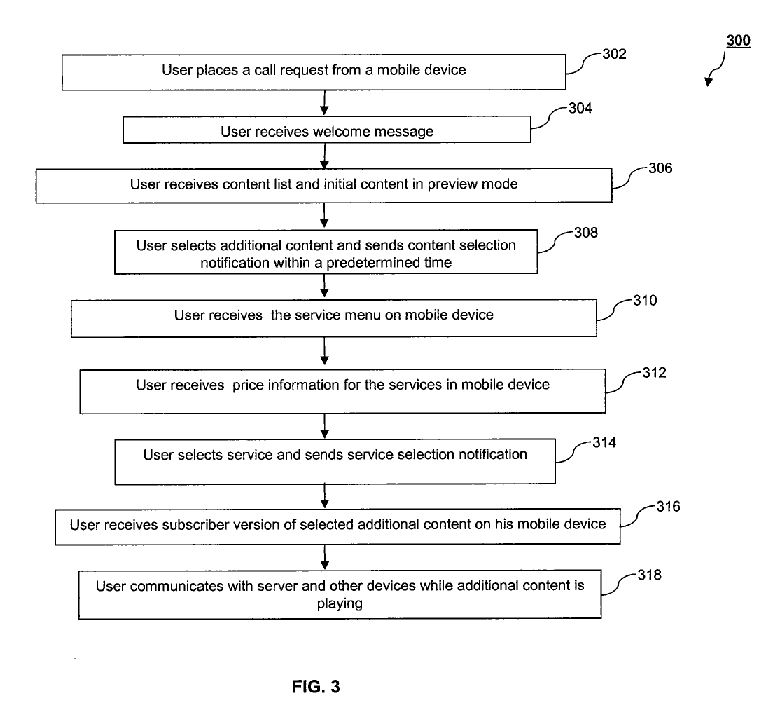

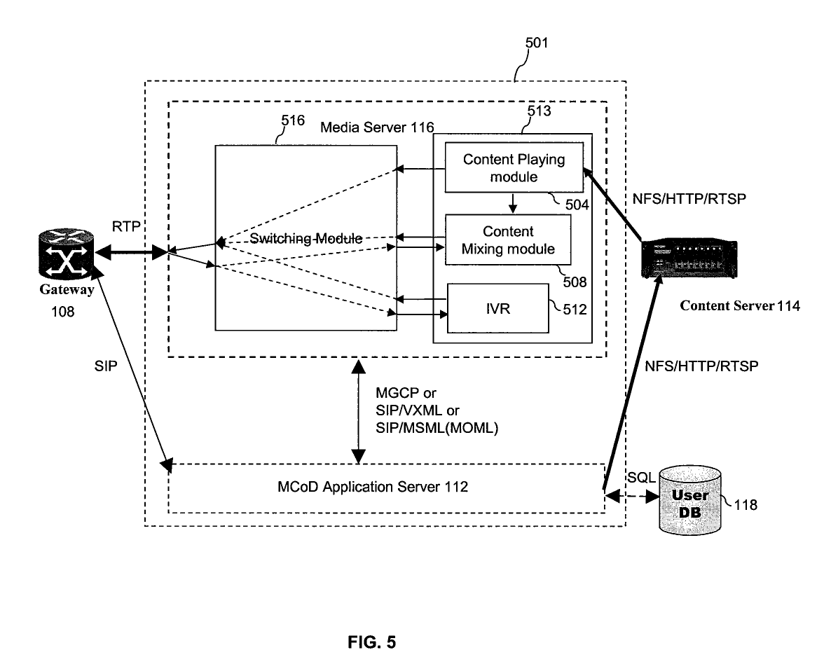

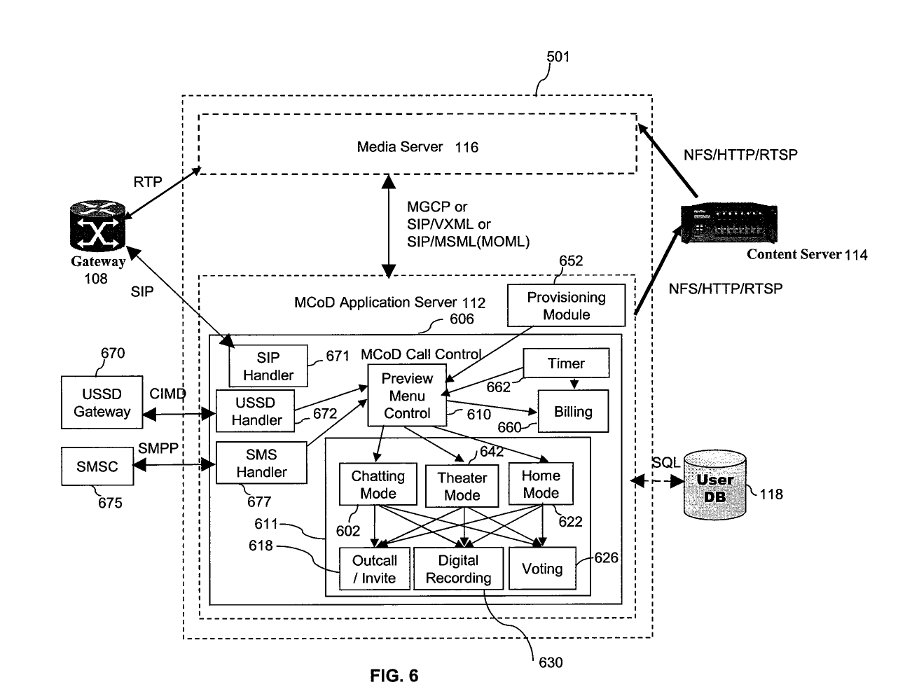

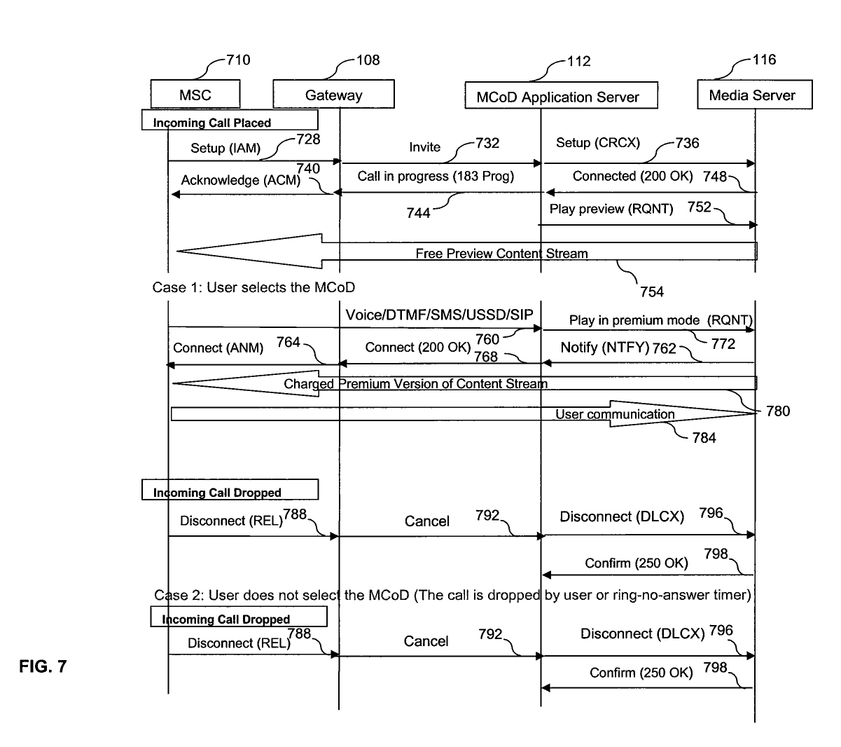

Enhanced mobile-content-on-demand services according to an embodiment of the present invention are described from the perspective of the user experience in FIGS. 3, 4, and 8. FIGS. 5 and 6 illustrate a system delivering enhanced mobile services to the user. The operation of the system is further described with respect to an example call flow diagram in FIG. 7.

### Example Enhanced Service Flow

In an embodiment, the user of mobile device 102 can enjoy free preview of audio/video contents including, but not limited to, a sports event, a movie, a news program, a TV program, a podcast program etc., for a predetermined time, e.g. 90 seconds. If the user of mobile device 102 decides to continue enjoying the audio/video in its full premium version, the call will be transferred to charged ‘enhanced mobile content on demand’ service call, in which the user can exercise enhanced interactive options, such as, selecting additional content(s), playing the content in digital recorder mode, voting on the program, chatting with others on the program, or inviting friends to a private chatting room to discuss topics related to the program.

FIG. 3 shows a flowchart 300 that shows example steps of enhanced MCoD services, according to an embodiment of the present invention. The steps of the flowchart are for illustrative purpose only, and do not have to take place in the order shown. There may be additional intermediate steps that are not shown in FIG. 3. Also, different embodiments may not use all the steps shown in FIG. 3. As will be discussed later, components shown in FIGS. 5 and 6 perform various steps of flowchart 300.

Flowchart 300 begins with step 302, in which a mobile user places a call request from his or her mobile device 102. The called number may be a service number provided to the mobile user by a content provider. In one embodiment, each digital program has one service number associated with it. In another embodiment, dialing a single service number gives the caller access to a sequence of videos, each in their preview mode.

In step 304, the user receives a welcome or introductory message. The message may be generated by the network, or by the content provider, or both, and the message may be delivered to the user by media server 116, or application server 112.

In step 306, the user receives an initial content, such as, a content list and audio and/or video clips in a free preview mode, on his or her mobile device 102. Application server 112 may implement a temporary connection between the user and media server 116, where media server 116 may stream the digital content in preview mode to mobile device 102. In case of a sequential content preview, transition from one preview clip to another should be as smooth as possible. However, whether it is a single preview or a sequential preview, the call is still not connected fully to initiate premium service charges. As will be discussed later with respect to FIG. 6, preview menu control module 610 sends out the initial content.

In step 308, the user selects additional content, e.g. premium version of a particular content from the initial content list, based on the preview. The selection is made and notified to application server 112 within a predetermined time for which the preview clip is played before the call either gets connected for billing purpose, or gets disconnected. Timer module 662 described in FIG. 6 controls this step.

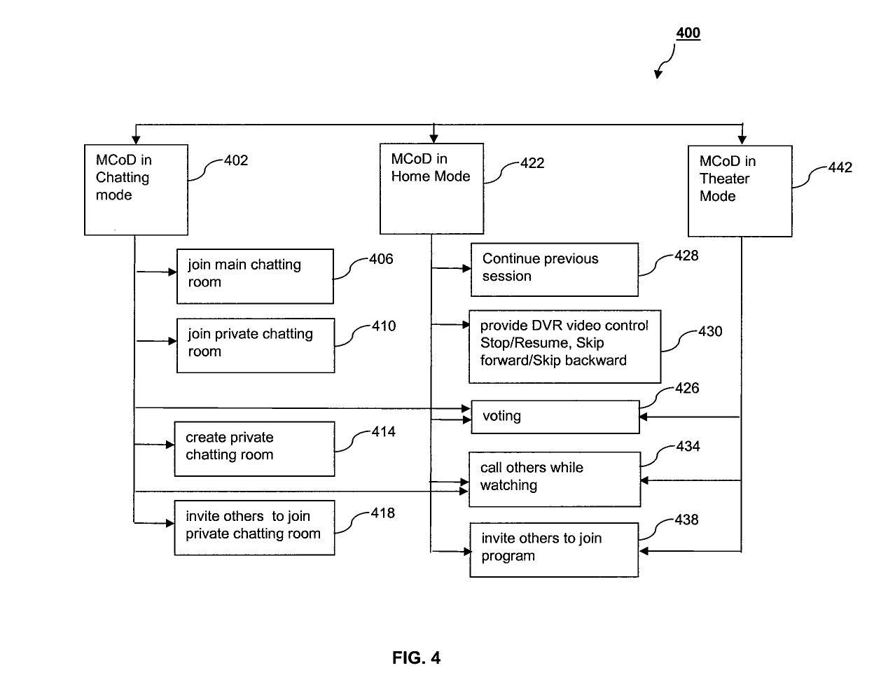

In step 310, the user receives a service menu associated with the selected additional digital content, and in step 312, the user receives the corresponding pricing information for the services. FIG. 4 discusses the various service menu from which a mobile user may select enhanced interactive services. Steps 310 and 312 may take place concurrently or sequentially. Service module 611 described in FIG. 6 performs steps 310 and 312. Note that the call has still not initiated premium service billing.

In step 314, the user selects one or more enhanced service options from the service menu, and sends notification of which services have been selected.

In step 316, the user starts receiving premium version of selected MCoD content on his mobile device 102, and application server 112 begins charging for premium services. The charges may show up in the mobile user's monthly service invoice, or in a separate invoice. Billing module 660 is FIG. 6 generates billing records, while media server 116 delivers additional content to mobile device 102.

In step 318, the user is enabled to send interactive communication signals related to the selected MCoD content to media server 116 or other mobile devices 102 connected to a subscriber network.

FIG. 4 shows a list 400 of the various example interactive enhanced services available to the users if they decide to make a transition from a free preview mode to a charged premium ‘Enhanced Mobile Content on Demand’ mode. The service menu is presented before or during the charged premium session, and the services selected by the user become available during the charged session.

The mobile user can engage in chatting with others while watching a video program or listening to an audio program by choosing service option 402, which provides MCoD in chatting mode. Chatting mode module 602 described later in FIG. 6 controls this service option. There are more options under service option 402. For example, the user can join a main chatting room (service option 406) or a private chatting room (service option 410), create his/her own private chatting room (service option 414), and invite others to join the private chatting room (service option 418). Other service options may be added in this mode. For example, service option 426 enables the user to vote on the program. Service option 434 enables the mobile user to make voice-based or text-message-based outcalls to other users while watching the program, and/or chatting about it. The video resource is shared for the main chatting room, while separate audio resource is maintained for each premium call. Both video and audio resources are reserved for private chatting room option.

Service option 422 enables the user to enjoy MCoD in a home mode. Home mode module 622 described later in FIG. 6 controls this service option. The mobile user can view the program as if in a private digital video player, and may record the show for future viewing. There are sub-categories of service options under the home mode service option 422. For example, service option 428 enables the user to continue from the last session, service option 430 enables the user to stop and resume video, skip forward and skip backward at will. Service option 426 enables the user to vote on the program. Content providers can collect viewer response or votes on the video program in real-time by this service. When the relevant vote question is heard or seen, the user can vote by pressing a key on the mobile phone. Service option 434 enables the mobile user to make outcalls to other users while watching the video program. Service option 438 enables the mobile user to invite other users to join the program. The mobile user can have a personal channel, possibly password-protected, established by choosing service option 422, where he/she can save the session and resume at the future time. Both video and audio resources are reserved for the user during this mode.

Service option 442 delivers MCoD in a theater mode. Theater mode module 642 described later in FIG. 6 controls this service option. Some of the sub-categories associated with MCoD in home mode, such as, voting option 426, outcalling option 434, and inviting option 438, are available in the theater mode as well, as shown in FIG. 4. Theater mode is a video broadcast mode. The video resource is shared in this mode. Only audio resource is reserved throughout the call for voting and outcall purpose.

### Example System Implementation

FIGS. 5 and 6 illustrate an example embodiment, where a media server 116 and an MCoD application server 112 are combined in an MCoD media platform 501, that communicates with mobile devices 102 (not shown) via gateway 108, and also communicates with content server 114 using Network File System/Hypertext Transfer Protocol/Real Time Stream Protocol (NFS/HTTP/RTSP). As will be described later, MCoD application server 112 communicates with user database 118 via SQL or other database query language. In the embodiment shown in FIGS. 5 and 6, components of a central controller 213 (described in FIG. 2) are distributed in MCoD application server 112, and media server 116. MCoD application server 112 and media server 116 communicate with each other using Media Gateway Control Protocol (MGCP), or Session Initiation Protocol/Voice eXtensible Markup Language (SIP/VXML), or Session Initiation Protocol/Media Server Markup Language (Media Objects Markup Language) [SIP/MSML(MOML)]. The protocols and languages shown in FIGS. 5 and 6 are included for illustrative purposes only. Other appropriate protocols may be used in alternative embodiments.

Media server 116 is capable of the basic functions, such as, streaming audio/video, Dual tone Multi-Frequency (DTMF) input collection, Text-to-Speech (TTS) conversion, audio/video mixing, volume control, conferencing, encoding, decoding, transcoding, compression etc. Media server 116 may include an interfacing module 513, and a switching module 516. Interfacing module 513 may include a content playing module 504, a mixing module 508, and an Interactive Voice/Video Response (IVR) module 512, among other components. Media server 116 may have more components that are not shown in FIG. 5.

Content playing module 504 is configured to play audio/video or other type of content from content server 114 to mobile device 102.

Content mixing module 508 is capable of mixing the audio and video contents. It is also configured to combine a plurality of individual audio/video Real-time Transport Protocol (RTP) streams into a multiple-view video chat room conference stream. For example, single-view, 4-view, 8-view chat room conference streams can be created by content mixing module 508.

Interactive Voice/Video Response (IVR) module 512 presents audio/video prompts to the user, collects user input (for example, input received by DTMF input or speech), and transmits user input to application server 112.

Switching module 516 can be a part of a switching fabric 216, described in FIG. 2. Switching module 516 channels RTP streams from mobile devices 102 to IVR module 512 and/or to mixing module 508. Switching module 516 also routes and channels output from content playing module 504 and/or content mixing module 508 to individual mobile devices 102.

FIG. 6 shows various example components of MCoD application server 112. MCoD application server 112 is coupled with gateway 108, content server 114, and user database 118.

The main functional component of MCoD application server 112 is a MCoD call control module 606, that controls the delivery of free preview content stream before billing starts, and manages the transition from a free preview mode to a charged premium mode of content delivery. MCoD Application server 112 may have more components that are not shown in FIG. 6. Call control module 606 receives user inputs from mobile devices 102 via gateway 108 and via media server 116. Call control module 606 may include (as shown in FIG. 6) or have interface with an SMS handler module 677, which receives user input sent as SMS messages via an SMS gateway (such as, a short message service center or SMSC 675) using Short Message Peer-to-Peer messaging protocol (SMPP). Call control module 606 may also include an Unstructured Supplementary Services Data (USSD) handler module 672, which receives user input sent as a USSD call via a USSD gateway 670, that uses a Computer Interface for Message Distribution (CIMD) protocol. Additionally, call control module 606 may include a SIP handler module 671, which receives user input via SIP signaling. The protocols are described here as examples only, and are not intended to limit the invention to these particular protocols.

Call control module 606 includes a preview menu control module 610, which presents the preview content list, and a service module 611, which regulates the enhanced service menu options discussed in FIG. 4. Some of the example enhanced service sub-modules shown in FIG. 6 are a chatting mode module 602, a theater mode module 642, a home mode module 622, an outcall/invite module 618, a digital recording module 630, and a voting module 626. Also included in call control module 606 is a billing module 660, and a timer module 662.

Preview menu control module 610 processes user input received via voice call, SIP signaling, SMS or USSD, and plays the preview contents. It also instructs the service module 611 to present service menu options, and deliver enhanced services in response to user input. Preview menu control module 610 also decides when to start the generation of billing records, and communicates that to billing module 660, which generates the actual billing record, such as, a Call Detail Record (CDR). Coupled to preview menu control module 610 and billing module 660, there is a timer module 662 that delays the delivery of additional content to the user until a signal indicative of a selection of additional content by the user is received, and disconnects the call if the signal is not received within a pre-determined time, e.g. 90 seconds.

Chatting mode module 602 enables the user to create or join a chatting room (service options 414, 406, and 410 in FIG. 4), where the user-selected content is being played. This module can process user input from IVR module 512, and enables the user to vote on the content using voting module 626 (service option 426 in FIG. 4), invite others to join the main chat room or a private chat room (service option 418 in FIG. 4), and make voice calls while watching the MCoD program using outcall/invite module 618 (service option 434 in FIG. 4).

Home mode module 622 enables the user to play the selected content on his mobile device 102, as if the content is being played in a personal digital media player (service option 422 in FIG. 4). Home mode module 602 interfaces with user database 118 via SQL or other database query language. User database 118 stores information about selected content with relevant time stamp for a particular user, so that the user can start or stop playing the content at any time, and can continue playing from where it was stopped last time (service option 428 in FIG. 4). Home mode module 622 processes user input from IVR module 512, and provides the user with real-time digital recorder controls, such as, stop/resume, skip forward/skip backward etc, using digital recording module 630, as described in FIG. 4 as service option 430. Home mode module 622 also enables the user to vote using voting module 626 (service option 426 in FIG. 4), and invite or call others using outcall/invite module 618 (service options 434 and 438 in FIG. 4).

Theater mode module 642 enables the user to watch or listen to the selected content as if in a theater, without real time digital recorder controls, such as, stop/resume, skip forward/skip backward, etc. Theater mode module 642 processes user input from IVR module 512, and enables the user to vote using voting module 626 (service option 426 in FIG. 4), and invite or call others using outcall/invite module 618 (service options 434 and 438 in FIG. 4). Additionally, in an example embodiment, the user may record the program for future viewing or listening.

It is to be appreciated by persons skilled in the art that chatting mode module 602, home mode module 622, and theater mode module 642 can communicate with each other to present a combined mode experience to the user. For example, chatting mode and home mode may be combined between two users in a private chat room, where each has the ability to stop/resume/playback the other user's content remotely in order to vote or chat about the program.

MCoD application server 112 also includes a provisioning module 652, which periodically checks the content list available at content server 114, and updates the preview list that the preview menu control module 610 presents to the user.

It is noted that call control module 606 including the functional modules shown in FIG. 6 may be implemented in hardware, software, firmware, or a combination thereof. Furthermore, while functionality is shown in separate modules 610, 611, 662, and 660, the invention is not limited to this configuration only. In other embodiments, functionality can be carried out in one module or distributed across two or more modules. Call control module 606 may reside in media server 116, in application server 112, or may be distributed between media server 116 and application server 112. Media server 116 may be a server dedicated to MCoD applications, or it may be a commercial server with multiple services including MCoD services. Similarly, application server 112 may be a multi-service commercial server, or a dedicated MCoD server. In an embodiment, call control module 606 may be a standalone unit (i.e. not part of an application server 112 or a media server 116) with its own interfacing module.

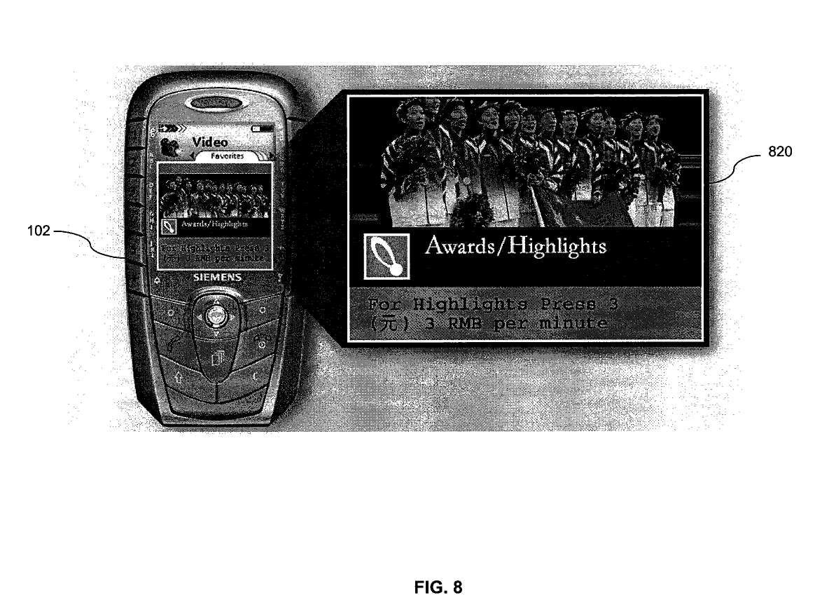

FIG. 8 shows an example of how the limited-time preview option can be displayed on the screen of a mobile device 102. As shown on the screen 820 of mobile device 102, a portion of the screen may play a preview version of a video program for a predetermined time, and display options from service menu (such as, “For Highlights Press 3”) and charging information (such as, “3 RMB per minute”) at the bottom of the screen. When the user presses the relevant dual-tone multi-frequency (DTMF) key, an SMS is sent to MCoD application server 112, which initiates a charged session, and coordinates delivery of a premium version of the digital program from a networked media server 116.

### Example Call Flow

As discussed with respect to the flowchart in FIG. 3, the present invention lets a mobile user enjoy free mobile content previews before the call is connected to generate billing record. To achieve this, timer module 662, in conjunction with preview menu control module 610, holds a ‘call connected’ signal (200 OK) from media server 116 for a predetermined time, and instead of the 200 OK signal, sends a ‘call in progress’ signal (183 Prog) to the user, allowing only a preview stream to be delivered, instead of a premium content stream. FIG. 7 schematically shows the flow of signal and data between various nodes of a mobile content-on-demand network. Signal and data flow occurs between four significant nodes, namely, a mobile switching center (MSC) 710 coupled to the individual mobile users via base stations (not shown), a gateway 108 or endpoint, an application server 112 and a media server 116.

Once the mobile user calls a service number, a call setup request message 728 (referred to as ‘initial address message’ or ‘IAM’) is conveyed from MSC 710 to endpoint/gateway 108. Message 728 is a Signaling System number 7 (SS7) signaling message. Endpoint/Gateway 108 then sends its own setup request signal 732 (referred to as ‘Invite signal’) to application server 112. Application server 112 in turn transmits another setup request signal 736 (referred to as ‘CRCX’) to media server 116. These exchanges of messages are described as a single step 302 in flowchart 300 in FIG. 3.

Media server 116 responds by sending ‘connected’ signal 748 (which is a 200OK signal) to application server 112. As discussed before, application server 112 does not immediately convey signal 748 back to MSC 710. Instead, application server 112 sends a ‘call in progress’ signal 744 (referred to as ‘183Prog’) to endpoint/gateway 108. Endpoint/Gateway 108 sends a ring-back signal or acknowledgement signal 740 (referred to as address completion message or ACM) to MSC 710, so that the mobile user knows that the call has not been dropped, and may see a welcome message on his mobile device screen. Step 304 of flowchart 300 describes this function.

Application server 112 sends a request signal 752 (referred to as ‘RQNT’) to media server 116, requesting media server 116 to play digital content (for example video clip) in preview mode.

Digital content list and preview segments 754 of digital content are delivered to the mobile user's mobile device for free, i.e. without charging the user. This function is described in step 306 of flowchart 300.

Once the mobile user gets to access the preview content, he/she has the option to either transition towards choosing premium services by selecting from available service menu, as shown in case 1 in FIG. 7, or simply disconnect the call without paying for premium services, as shown in case 2 in FIG. 7.

In case 1, mobile user may browse a list of digital content, choose a program, and send his/her selection directly to application server 112 by sending a voice/DTMF/short message/USSD/SIP signal 760, consisting of one or more digits. This is shown in step 308 of flowchart 300.

Another round of communication takes place between application server 112 and a mobile device connected to MSC 710 via a base station, where application server 112 plays a service menu and charging information (as shown in steps 310 and 312 of flowchart 300), and receives user-selected service options as Voice/SIP/DTMF/USSD/SMS message (as shown in step 314 of flowchart 300).

Application server 112 translates user input 760 to media server 116 by sending a request signal (RQNT) 772, which has the SIP information embedded. Media server 116 notifies application server 112 about the requested content corresponding to user input 760 by sending NTFY signal 762. Application server 112 sends a ‘connected’ 200 OK signal 768 to endpoint/gateway 108, and endpoint/gateway 108 sends another ‘connected’ signal 764 (often referred to as ‘answer message’ or ‘ANM’) to the user connected through MSC 710. Now the call is completely connected and the system starts generating one or more billing records, as shown in step 326 of flowchart 300.

A communication path is established between media server 116 and mobile user device 102 (not shown), through which content server 114 (not shown) delivers charged premium version of digital content stream 780. The user is also enabled to communicate and send feedback and interactive input signals to media server 116. User communication 784 may include audio, video, data stream, text, or a combination thereof.

As discussed before, there is a timer on the application server of the network side, which can be set to any predetermined time. For example, the timer may set to 90 seconds from sending time of setup request message 728 to receiving time of answering message 764, so the user can view the video for 90 seconds for free.

In case 1, the user made the choice within the predetermined time, e.g. 90 seconds.

In case 2, the user does not send any input 760 or sends an incorrect input that does not correspond to any digital content or service option. In that case, the call will be terminated at the end of the predetermined time (for example at 90 seconds) without incurring any charge to the user. MSC sends disconnect signal 788 to endpoint/gateway 108. Endpoint/gateway 108 sends a disconnect or cancel signal 792 to application server 112, and application server 112 sends a disconnect signal (for example, DLCX) 796 to media server 116. Media server 116 confirms dropping the call by sending confirmation signal (250 OK) 798 to application server 112.

It is noted that in case 1 also, the call is disconnected at the end of playing the premium digital content, and billing stops as soon as application server 112 receives call end confirmation signal 798 from media server 116. Also, in case of a prepaid service, the call can be dropped when the caller's account runs out of money.

Some of the signals shown in FIG. 7 are not actual protocol requests (e.g., Play in premium mode request 772), but general descriptions which may translate into different messages according to the protocol used in a particular deployment.

Embodiments of the present invention enable large content service providers to provide a variety of digital program with many enhanced services. Embodiments of the present invention also enable smaller content service providers to provide special digital programs at a competitive cost utilizing existing mobile network infrastructure.

### Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for providing content on demand to a mobile user device connected to a network, the method comprising:
sending an initial content to a mobile user device for preview by a user after initiation of a call and prior to initiation of a billing charge for the call;
receiving a signal from the user indicative of a selection of additional content by the user;
initiating connection of the call to allow billing charges after the user has selected the additional content; and
initiating delivery of the selected additional content to the mobile user device after the user has selected the additional content.

2. The method of claim 1, wherein the method further comprises:
disconnecting the call if the signal indicative of a selection of additional content by the user is not received within a pre-determined time.

3. The method of claim 1, wherein the method further comprises:
prior to delivering the selected additional content, sending a corresponding price information associated with delivery of the selected additional content.

4. The method of claim 1, wherein the method further comprises:
presenting a service menu comprising one or more enhanced service options associated with the selected additional content.

5. The method of claim 4, wherein the method further comprises:
sending a corresponding price information associated with the one or more enhanced service options.

6. The method of claim 4, wherein the method further comprises:
receiving a signal from the user indicative of a selection of at least one of the enhanced service options by the user.

7. The method of claim 1, wherein the method further comprises:
after initiating delivery of the selected additional content to the mobile user device, receiving a first interactive input signal from the user, wherein the first interactive input signal is related to the selected additional content.

8. The method of claim 7, wherein the first interactive input signal is directed to a second user connected to the network.

9. The method of claim 8, wherein the method further comprises:
receiving a request from any of the users to deliver the selected additional content to the second user's mobile device; and
initiating delivery of the selected additional content to the second user's mobile device.

10. The method of claim 8, wherein the method further comprises:
receiving a second interactive input signal from the second user, wherein the second interactive input signal is related to the selected additional content.

11. The method of claim 10, wherein the second interactive input signal is indicative of the second user's response to the first interactive input signal.

12. The method of claim 1, wherein the initial content may be a plurality of contents in preview mode.

13. A system for providing content on demand to a mobile user device connected to a network, the system comprising:
a preview menu control module that sends out an initial content to the mobile user device for preview by a user after initiation of a call and prior to initiation of a billing charge for the call; and
coupled to the preview menu control module, a billing module that initiates generation of billing charges after the user has selected additional content to be delivered to the mobile user device.

14. The system of claim 13, wherein the system further comprises:
a timer module that disconnects the call if the signal indicative of a selection of additional content by the user is not received within a pre-determined time.

15. The system of claim 13, wherein the system comprises a service module that presents one or more enhanced service options associated with the selected additional content.

16. The system of claim 15, wherein the service module sends a corresponding price information associated with the one or more enhanced service options.

17. The system of claim 15, wherein the service module further comprises:
a home mode module, wherein the home mode module delivers a home mode enhanced service option associated with the selected additional content.

18. The system of claim 17, wherein the home mode module further includes:
a digital recorder module that allows the user to start, stop, and resume playing of the selected additional content at any time, skip forward and skip backward while the selected additional content is playing, and record the selected additional content for future playing;
a voting module that allows the user to vote on the selected additional content;
an outcall/invite module that allows the user to call or send a message to a second user while playing the selected additional content to invite the second user to have the selected additional content delivered to the second user's mobile device, and exchange opinion with the second user regarding the selected additional content.

19. The system of claim 15, wherein the service module further comprises:
a theater mode module, wherein the theater mode module delivers a theater mode enhanced service option associated with the selected additional content.

20. The system of claim 19, wherein the theater mode module further includes:
a voting module that allows the user to vote on the selected additional content;
an outcall/invite module that allows the user to call or send a message to a second user while playing the selected additional content to invite the second user to have the selected additional content delivered to the second user's mobile device, and exchange opinion with the second user regarding the selected additional content.

21. The system of claim 15, wherein the service module further comprises:
a chatting mode module, wherein the chatting mode module delivers a chatting mode enhanced service option associated with the selected additional content.

22. The system of claim 20, wherein the chatting mode module enables the user to create and join a chat room where the selected additional content is playing, invite a second user to join the chat room, and exchange opinion with the second user regarding the selected additional content in the chat room.

23. The system of claim 22, wherein the chatting mode module further includes:
a voting module that allows the user to vote on the selected additional content.

24. The system of claim 22, wherein the chat room is a private chat room.

25. The system of claim 22, wherein the chat room is a public chat room.

26. The system of claim 13, wherein the initial content may be a plurality of contents in preview mode.

27. A system for providing content on demand to a mobile user device connected to a network, the system comprising:
an interfacing module that interacts with the mobile user device by collecting input from a user and delivering digital content to the mobile user device during a call;
and
a call control module that communicates with the interfacing module, comprising:
a preview menu control module that sends out an initial content to the mobile user device for preview by the user after initiation of the call and prior to initiation of a billing charge for the call;
coupled to the preview menu control module, a timer module that delays the delivery of additional content to the user until a signal indicative of a selection of additional content by the user is received, and disconnects the call if the signal is not received within a pre-determined time;
coupled to the preview menu control module, a service module that presents one or more enhanced service options to the user once the user has selected the additional content to be delivered to the mobile user device; and
coupled to the preview menu control module and the timer module, a billing module that initiates generation of billing charges when the selected additional content is delivered to the mobile user device.

28. The system of claim 27, wherein the one or more enhanced service options include a home mode enhanced service option, a theater mode enhanced service option, and a chatting mode enhanced service option.
